(19) United States
(12) Patent Application Publication
(10) Pub. No.: US 2011/0088501 A1
(43) Pub. Date: Apr. 21, 2011

(54) STEERING COLUMN FOR VEHICLE

(75) Inventor: Joo Yeol PARK, (US)

(73) Assignee: MANDO CORPORATION

(21) Appl. No.: 12/906,644

(22) Filed: Oct. 18, 2010

(30) Foreign Application Priority Data
Oct. 20, 2009 (KR) 10-2009-0099628
Oct. 5, 2010 (KR) 10-2010-0096879

(51) Int. Cl. B62D 1/18; B62D 1/16

(52) U.S. Cl. 74/493; 74/492

(57) ABSTRACT

By a steering column for a vehicle, it is possible to maintain operating force of a control lever and supporting force of an outer tube and an inner tube in a uniform manner when tightening and releasing the control lever for tilt or telescopic operation and to increase the strength of the steering column as a whole, to thereby prevent deformation and breakage of the steering column at the time of the driver's operation of the steering wheel.

### CROSS-REFERENCE TO RELATED APPLICATION

This application claims priority from and the benefit of Korean Patent Application No. 10-2009-0099628, filed on Oct. 20, 2009 and Korean Patent Application No. 10-2010-0096879, filed on Oct. 5, 2010, which are hereby incorporated by reference for all purposes as if fully set forth herein.

### BACKGROUND OF THE INVENTION

1. Field of the invention

The present invention relates to a steering column for a vehicle. More particularly, the present invention relates to a steering column for a vehicle, which makes it possible to uniformly maintain operating force of a control lever and supporting force of an outer tube and an inner tube when tightening and releasing the control lever for tilting or telescopic operation, and to increase the strength of the steering column as a whole, to thereby prevent deformation and breakage of the steering column at the time of the driver's operation of the steering wheel.

2. Description of the Prior Art

As generally known in the art, the steering column is an apparatus which encloses a steering axis for transmitting rotational force caused by the driver's operation of the steering wheel to a rack-pinion mechanism and which fixes the position of the steering axis by being coupled to the vehicle body through a bracket.

The steering column may additionally include a telescopic function or a tilting function for the driver's convenience, wherein a tilt device is provided for adjusting a fixed angle of the steering wheel and wherein a telescopic device is formed by coupling two hollow tubes to each other so as to enable the tubes to retract and extend in an axial direction and has the function of absorbing impact energy by collapsing the steering wheel and the steering column at the time of the vehicle collision.

Accordingly, the steering apparatus may be divided into a telescopic type or a tilt type depending on the function thereof. In some cases, the tilting function may be added to the telescopic steering apparatus, and the driver can adjust the protrusion of the steering wheel or the tilt angle to be matched with his/her height or figure using these function, so that the driver can smoothly carry out the steering operation.

FIG. 1 shows an exploded perspective view representing a part of the steering column for a vehicle of the prior art.

Referring to FIG. 1, the steering column for a vehicle of the prior art comprises: an outer tube 100 for receiving a steering axis 175; an inner tube 170 inserted into the outer tube; a lower mounting bracket 165 for fixing the inner tube to a vehicle body; an upper mounting bracket 105 installed at the upper side of the outer tube 100 and fixed to the vehicle body; a distance bracket 180 integrally fixed to the outer tube 100 and formed with a telescope elongated hole 185; a tilt bracket 150 being integral with the upper mounting bracket 105 and formed with a tilt elongated hole 110; a fixed gear 145 provided at the outer face of the tilt bracket 150; a mobile gear 140 engaged with or disengaged from the fixed gear 145; a tilt bolt 130 penetrating through the tilt elongated hole 110; a cam 135 coupled with the mobile gear 140; a washer 125 and a nut 120 for fixing the control lever 115 to the cam 135; and a gear spring 142 disposed between the mobile gear 140 and the fixed gear 145.

The tilting or telescopic operation is caused by tightening or releasing the control lever 115. When the control lever 115 is tightened, the compressive force is applied to the outer tube 100 by narrowing the tilt bracket 150, and thus the compressive force makes the outer tube 100 and the inner tube 170 to be closed. Accordingly, the tilting or telescopic operation becomes unavailable. To the contrary, when the control lever 115 is released, the compressive force applied to the outer tube 100 and the inner tube disappears and thus the tilting or telescopic operation becomes available.

The telescopic operation is attained with the steps of: releasing the control lever 115; shifting the position of a tilt bolt 130 along the telescope elongated hole 185 formed at the distance bracket 180; and tightening the control lever 115.

The tilting operation is attained with the steps of releasing the control lever 115; shifting the position of the tilt bolt 130 along the tilt elongated hole 110; and tightening the control lever 115.

When the control lever 115 is tightened, the outer tube 100 and the steering axis 175 are fixed to each other. Otherwise, when the control lever 115 is released, the outer tube 100 and the inner tube 170 are tilted about a tilt center 160 or the steering column can retract or extend in the axial direction.

However, the steering column for a vehicle of the prior art has the problem in that the areas of the tilt bracket and the distance bracket, through which the tilt bolt and the control lever tighten the steering column, receive a concentrated load, and thus the supporting force and the strength of the column are weak.

In particular, due to the lower strength of the tilt bracket and the distance bracket, the operation power of the control lever varies depending on the position of the control lever along the telescope elongated hole, which is determined when the driver tightens the control lever. Accordingly, the driver's feeling about the tilting or telescopic operation is deteriorated.

### SUMMARY OF THE INVENTION

Accordingly, the present invention has been made to solve the above-mentioned problems occurring in the prior art, and an object of the present invention is to provide a steering column for a vehicle which makes it possible to uniformly maintain operation force of the control lever and the supporting force of the outer tube and the inner tube when tightening and releasing the control lever for tilting or telescopic operation, and to increase strength of the steering column as a whole, so that the deformation and the breakage of the steering column can be prevented at the time of the driver's operation of the steering wheel.

In order to accomplish this object, there is provided a steering column for a vehicle comprising: a hollow inner tube enclosing a steering axis; a hollow outer tube into which said inner tube is inserted; and a distance bracket having a hollow space into which said outer tube is inserted, a slit formed by cutting a portion of the distance bracket in a direction of the steering axis and being open at an end thereof, and a small diameter portion formed by reducing an inner diameter of an inner peripheral surface of the hollow space at said open end of the slit.

In the use of the steering column for a vehicle in accordance with the present invention, it is possible to maintain the operating force of the control lever and the supporting force of the outer tube and the inner tube in a uniform manner when tightening and releasing the control lever for tilting or telescopic operation. Also, it is possible to increase the strength of the steering column as a whole. Accordingly, the deformation and the breakage of the steering column may be prevented at the time of the driver's operation of the steering wheel.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view illustrating a portion of a steering column of the prior art.

FIG. 2 is a perspective view illustrating a portion of a steering column in accordance with an embodiment of the present invention.

FIG. 3 is a cross-sectional view of FIG. 2.

FIG. 4 is a perspective view illustrating a distance bracket included in the steering column for a vehicle in accordance with the present invention.

FIGS. 5, 6 and 7 are cross-sectional views of the distance bracket included in the steering column for a vehicle in accordance with the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

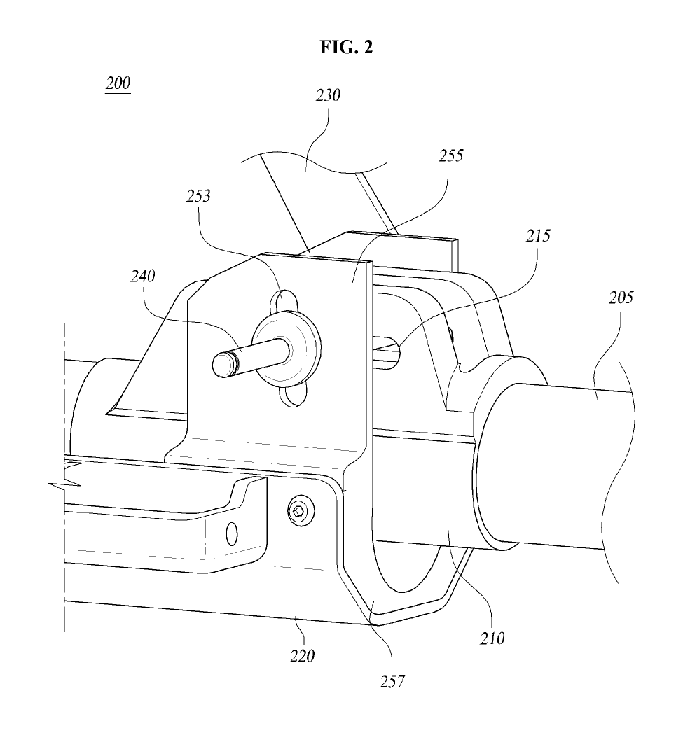

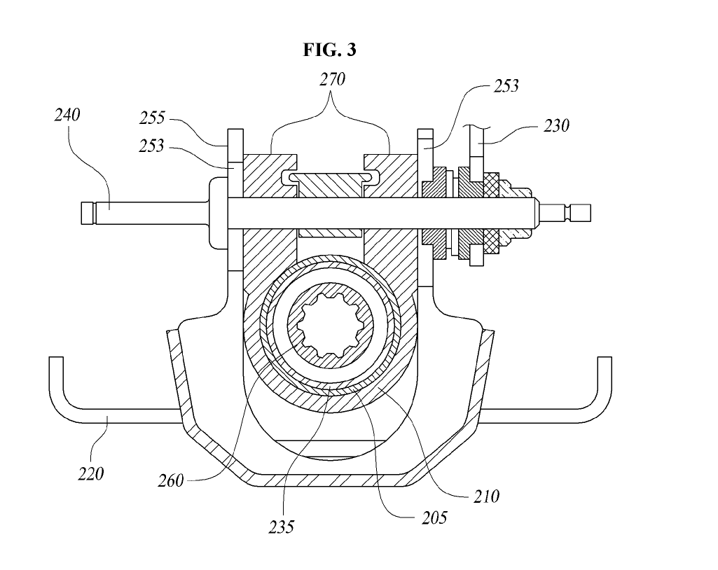

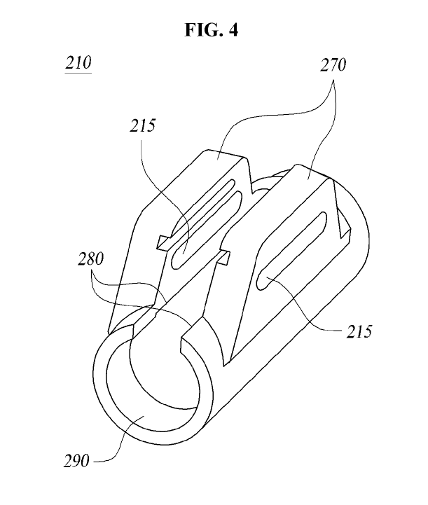

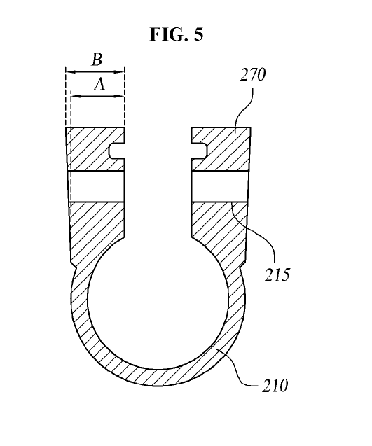

FIG. 2 is the perspective view illustrating the portion of the steering column in accordance with an embodiment of the present invention; FIG. 3 is the cross-sectional view of FIG. 2; FIG. 4 is the perspective view illustrating the distance bracket included in the steering column for a vehicle in accordance with the present invention; and FIGS. 5, 6 and 7 are the cross-sectional views of the distance bracket included in the steering column for a vehicle in accordance with the present invention.

As shown in the drawings, the steering wheel 200 for a vehicle in accordance with the present invention comprises: a hollow inner tube 235 enclosing a steering axis 260; a hollow outer tube 205 into which said inner tube 235 is inserted; and a distance bracket 210 having a hollow space into which said outer tube 205 is inserted, a slit 280 formed to be open at an end thereof by cutting a portion of the distance bracket in a direction of the steering axis 260, and a small diameter portion 209 formed by reducing an inner diameter of an inner peripheral surface of said hollow space at said open end of said slit 280.

In the steering column 200 of the present invention, the inner tube 235 is inserted into the outer tube 205. When tightening or releasing a tilt bolt 240, which extends through a hole for telescoping 215 of the distance bracket 210, and a control lever 230, the distance bracket 210 retracts or extends in a radial-horizontal direction, i.e., in a direction perpendicular to the steering axis 260 to thereby compress or release the outer tube 205 and the inner tube 235. Accordingly, the tilting function or the telescoping function can be performed.

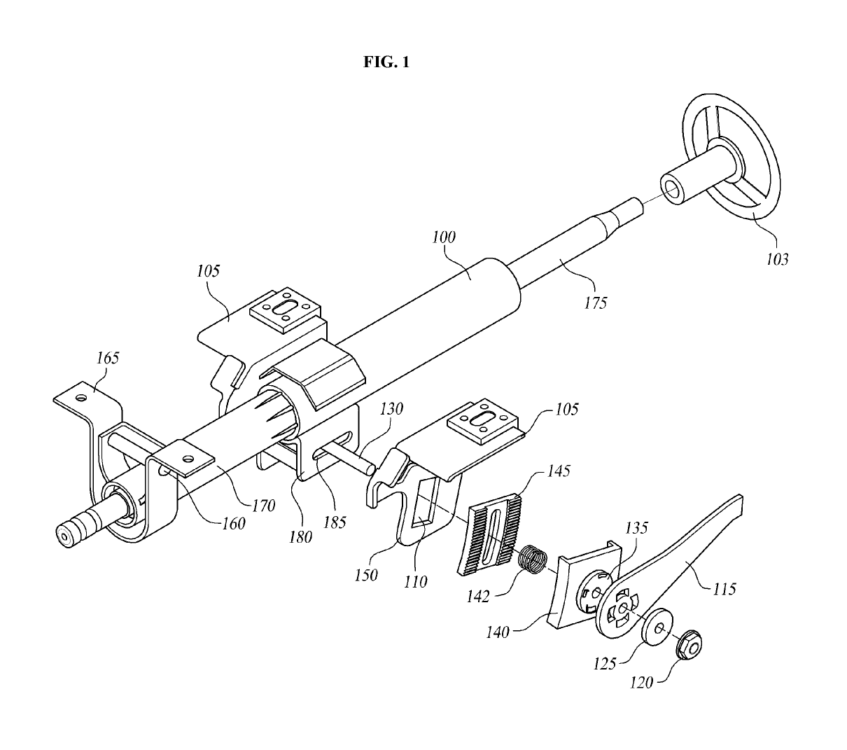

The inner tube 235 has a hollow shape enclosing the steering axis 260 and is fixed to the vehicle body by way of the lower mounting bracket (see ‘165’ of FIG. 1). The inner tube 235 rotates about the hinge axis (see ‘160’ of FIG. 1) included in the lower mounting bracket at the time of the tilting operation. The inner tube 235 serves as a guide because the outer tube 205 slides along the inner tube 235 in the direction of the steering axis 260 at the time of the telescopic operation.

The outer tube 205 formed with a hollow space is coupled to the inner tube 235 fixed to the vehicle body by receiving the inner tube 235 in the hollow space of the outer tube 205. The hollow distance bracket 210 formed with the slit 280 is coupled to the outer tube 205

The distance bracket 210 has the hollow space into which said outer tube 205 is inserted. The distance bracket 210 has a slit 280, which is formed by cutting a portion of the distance bracket in the direction of the steering axis 260 and being open at an end thereof. Also, the distance bracket 210 has a small diameter portion 209 formed by reducing an inner diameter of an inner peripheral surface of the hollow space at the open end of the slit 280.

When the driver tightens the control lever 230 after having released the control lever and having set the steering column to match the steering column to the driver for the purpose of the tilting or the telescopic operation, the slit 280 makes it easy to retract the distance bracket 210 to thereby press the outer tube 205.

At the other end opposite to the open end of the slit 280, the distance bracket is not formed with the slit 280, and thus it is possible for the steering column to maintain the strength thereof. Accordingly, it prevents the breakage or the deformation of the distance bracket 210 and the outer tube 205 due to the twist load applied to the steering column at the time of the driver's operation of the steering wheel.

At spaced positions on either side of the slit 280, guide portions 270 are provided for supporting the tightening of the control lever 230. The guide portions 270 are formed to extend in the radial-horizontal direction on either side of the slit 280 and are spaced apart to oppose to each other.

Specifically, in order to narrow the slit 280, which has a long slit-shape extending in the direction of the column axis 260, the guide portions 270 having a flange shape with a predetermined thickness are formed to be perpendicular to the direction of the column axis 260 on the outer surface of the distance bracket 210. Each of the guide portions 270 is formed with a hole for telescoping 215 extending in the direction of the column axis 260. A tilt bolt 240 extends through the hole for telescoping 215 and slides along the hole for telescoping 215 at the time of telescopic operation.

As shown in FIG. 5, each of the guide portions 270 has a taper shape, the thickness of which increases from the outer surface of the distance bracket 210 on either side of the slit in the radial-horizontal direction. Accordingly, the retraction and the relaxation of the slit occurs smoothly during the manipulation of the control lever, while the peripheral area of the hole for telescoping 215 through which the tilt bolt 240 extends has the higher strength, so that the distance bracket may maintain the twist strength as a whole.

In other words, the thickness (A) of the guide portion 270 is small at the outer peripheral surface of the distance bracket 210, whereas the thickness (B) of the guide portion 270 becomes greater toward an end thereof in the radial-horizontal direction.

The guide portions 270 are fixed to the vehicle body through the tilt bracket 255 and the mounting bracket 220. The guide portions 270 are restricted by the tilt bolt 240, which extends through the tilt bracket 255 and the hole for telescoping 215, and the control lever 230, so that they retract or relax to enable the tilting or the telescopic operation when the driver manipulates the control lever 230.

On an inner peripheral surface of the hollow space of the distance bracket located at the open end of the slit 280, the small diameter portion 290 is provided with a reduced diameter. Here, the small diameter portion 290 is formed to be stepped with respect to the residual inner peripheral surface of the distance bracket. In some cases, the small diameter portion 290 has such a taper shape that the inner diameter of the small diameter portion gradually decreases from the inner position of the distance bracket 210 to the open end of the slit 280.

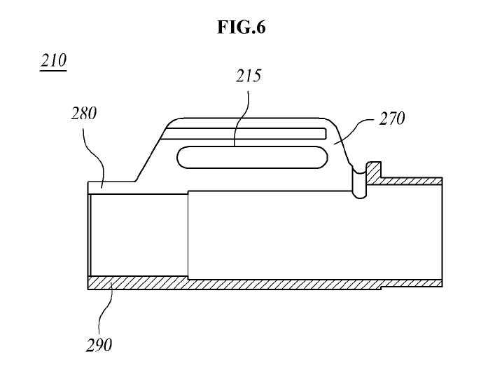

As shown in FIG. 6, the inner diameter of the small diameter portion 290 is reduced to form a stepped portion on the inner peripheral surface of the hollow space extending from an end of the hole for telescoping 215 adjacent to the slit to the open end of the slit 280.

Accordingly, the stepped zone of the small diameter portion 290 corresponds to the inner peripheral surface of the hollow space extending from the end of the hole for telescoping 215 adjacent to the slit 280 to the open end of the slit 280.

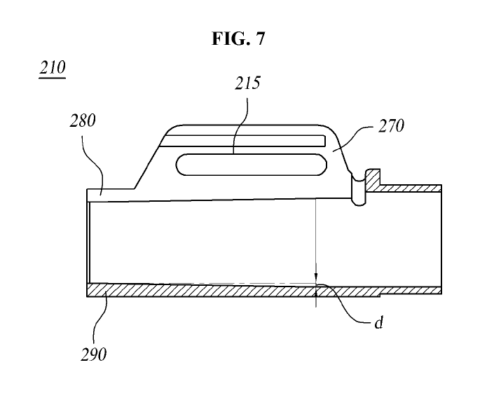

As an alternative, the small diameter portion 290 may be formed to have the taper shape on the inner peripheral surface of the hollow space by gradually reducing the inner diameter from the other end of the hole for telescoping 215 opposite to the slit 280 to the open end of the slit 280 as shown in FIG. 7. Accordingly, the difference d in the inner diameters may be defined between one end at which the taper shape of the small diameter portion 290 starts and the other end at which the taper shape ends

In this case, the tapered zone of the small diameter portion 290 corresponds to the inner peripheral surface of the hollow space extending from the end of the hole for telescoping 215 opposite to the slit 280 to the open end of the slit 280.

Accordingly, when tightening the tilt bolt 240 extending through the tilt bracket and the hole for telescoping 215, the open end of the slit 280 formed in the distance bracket 210 is narrowed to make the small diameter portion 290 to compress the outer tube 205 first, so that the tightening force of the tilt bolt 240 can be uniformly maintained.

In other words, when tightening the control lever 230 after having released the control lever 230 and having set the steering column at a desired position for the purpose of the tilting or the telescopic operation, the retraction of the distance bracket 210 is caused. Here, because the small diameter portion 290 tightens the outer tube 205 first, the driver's operation force for the control lever 230 is uniformly maintained regardless of where the tilt bolt 240 is located along the hole for telescoping 215.

According to the present invention in which the steering column for a vehicle comprises the above-described configuration and structure, the operation force of the control lever and the supporting force of the outer tube and the inner tube are uniformly maintained. Also, the strength of the steering column can be increased as a whole, and thus the deformation and the breakage of the steering column are prevented when the driver manipulates the steering wheel.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A steering column for a vehicle, comprising:
a hollow inner tube enclosing a steering axis;
a hollow outer tube into which said inner tube is inserted; and
a distance bracket having a hollow space into which said outer tube is inserted, a slit formed by cutting a portion of the distance bracket in a direction of the steering axis and being open at an end thereof, and a small diameter portion formed by reducing an inner diameter of an inner peripheral surface of the hollow space at said open end of the slit.

2. The steering column for a vehicle as claimed in claim 1, wherein said small diameter portion of the distance bracket is formed to be stepped with respect to the inner peripheral surface of the distance bracket.

3. The steering column for a vehicle as claimed in claim 1, wherein said small diameter portion of said distance bracket has such a taper shape that the inner diameter of said small diameter portion gradually decreases from the inner position of the distance bracket to the open end of the slit.

4. The steering column for a vehicle as claimed in claim 1, wherein said distance bracket is formed with guide portions having a flange shape with a predetermined thickness in order retract said slit on either side; and said guide portions is formed to have a taper shape, the thickness of which increases from the outer peripheral surface of the distance bracket to an outer end of the guide portions.

5. The steering column for a vehicle as claimed in claim 4, wherein said guide portion includes a hole for telescoping extending in the direction of the steering axis.

6. The steering column for a vehicle as claimed in claim 5, wherein the inner diameter of the small diameter portion is reduced to form a stepped portion on the inner peripheral surface of the hollow space from an end of the hole for telescoping adjacent to the slit to the open end of the slit.

7. The steering column for a vehicle as claimed in claim 5, wherein the small diameter portion is formed to have the taper shape on the inner peripheral surface of the hollow space by gradually reducing the inner diameter from the other end of the hole for telescoping opposite to the slit to the open end of the slit.
